(19) United States
(12) Patent Application Publication
(10) Pub. No.: US 2020/0390110 A1
(43) Pub. Date: Dec. 17, 2020

(54) ENGINEERED OIL/POLYMER BLENDS FOR PEST CONTROL

(71) Applicant: Ronald Edwin Lane, Colfax, CA (US)

(72) Inventor: Ronald Edwin Lane, Colfax, CA (US)

(73) Assignee: Circadian Crop Sciences LLC, Davis, CA (US)

(21) Appl. No.: 16/438,196

(22) Filed: Jun. 11, 2019

(51) Int. Cl. A01N 65/24; A01N 65/08; A01N 65/12; A01N 65/40; A01N 65/22; A01N 65/18; A01N 59/00; A01N 31/02; A01N 43/16; A01N 55/00; A01N 25/04

(52) U.S. Cl. CPC A01N 65/24; A01N 65/08; A01N 65/12; A01N 65/40; A01N 65/22; A01N 25/04; A01N 59/00; A01N 31/02; A01N 43/16; A01N 55/00; A01N 65/18

(57) ABSTRACT

The present invention relates to a base formula wherein vegetable and/or other plant-based oils are alkalized with a bicarbonate salt to a pH between 7.5 and 9.7, treated with one or more emulsifiers to create an oil in water emulsion, and then coupled with a polymer to create an oil/polymer film for smothering arthropod pests and to coat plant surfaces for the purposes of deterring herbivory and to serve as protective barrier between pathogens and plant surfaces. Includes additions of wetting agents to improve spray coverage, and additions of plant essential oils to offer multiple modes of action to increase the breadth of pests controlled.

### FIELD OF THE INVENTION

The present invention relates to the field of pesticide formulation and application. It builds upon integrating principles of agronomy, mycology, bacteriology, agrochemistry, plant protection, and plant physiology.

### BACKGROUND OF THE INVENTION

Horticultural oils are widely used for controlling arthropod pests. They function by clogging spiracles used for air exchange; thus, their known MOA is via asphyxiation. These oils are one of the few pesticides that insect and mite pests have yet to develop appreciable resistance against; this despite widespread use in excess of one-hundred years. Coupled with soaps or copper, horticultural oils can also prevent and stop certain fungal and bacterial plant pathogens. Horticultural oils are not without their drawbacks. The oils used today are almost all of a highly refined petroleum, a non-renewable resource. Most organisms are unable to metabolize petroleum derived oils and these oils can remain in the environment for long periods. Horticultural oils will also burn plants if sprays are within two weeks of a sulfur application. As sulfur is so widely used in agriculture, it often excludes horticultural oils as a pest control option. Therefore, improvements in horticultural oils are necessary to make them more compatible with sulfur, and to reduce their half-life in the environment, while maintaining and enhancing their ability to control pests.

### SUMMARY OF THE INVENTION

The base composition of the invention is a pesticide wherein vegetable and/or other plant-based oils are alkalized with a base to a pH between 73 and 9.7, treated with one or more emulsifiers to create an oil in water emulsion (when mixed with water prior to application), and coupled with a polymer to create an oil/polymer film for purposes of controlling arthropod pests and to coat plant surfaces to deter herbivory and to serve as a protective barrier between pathogens and plant surfaces.

In another embodiment a wetting agent (HLB between 7 and 10) is added to the base composition of the invention to reduce surface tension of ready to use product. Wetting agents are commonly used in agriculture to spread spray droplets, improving pesticide coverage of plants and pests.

In another embodiment least one plant derived oil commonly recognized as bearing pesticidal properties is added to the base composition, with or without a wetting agent, including but not limited to: cedarwood, cinnamon, citronella, clove, cornmint, eugenol, garlic, geranium, lemon grass, linseed, mint, peppermint, rosemary, spearmint, thyme, and wintergreen.

### DETAILED DESCRIPTION OF THE INVENTION

### Definitions

Agar: a mixture of the linear polysaccharide agarose and a heterogeneous mixture of agaropectin. It forms the supporting structure in the cell walls of certain species of algae.

Arthropod: refers to a member of the phylum Arthropoda, which includes the classes of insects and arachnids.

Bicarbonate: any salt containing the HCO3- anion, typically NaHCO3, KHCO3, and NH4HCO3.

Carrageenan: a family of linear sulfated polysaccharides (Kappa, iota, and Lambda forms), extracted from red edible seaweeds, and that differ primarily by the number and position of the ester sulfate groups on the repeating galactose units. They are widely used in the food industry for their gelling, thickening, and stabilizing properties. Their main application is in dairy and meat products due to their strong binding of proteins.

Cellulose: a naturally occurring carbohydrate-based polymer that serves as the structural foundation of the cell walls of vascular plants and many forms of algae. Unlike starch-based polymers, cellulose is insoluble in water.

Chitin: a long-chain polymer of N-acetylglucosamine. Chitin is the primary component of cell walls in fungi and the exoskeletons of arthropods.

Collagen: consists of amino acids wound together to form triple-helices of elongated fibrils, and is the main structural protein in connective tissues of mammals.

Efficacy: the ability to produce a desirable or intended result.

Gum Arabic: the gum of certain acacia trees which are polymer forming polysaccharides and emulsifiers.

Horticultural oil: narrow range oils that are combined with water and sprayed to control insect and mite pests. The exact MOA is classified by IRAC as “UNE” for substances of botanical essence of unknown or uncertain MOA, though it is generally believed these oils plug exoskeletal pores used for air exchange and death is by asphyxiation.

HLB: Hydrophilic-Lipophilic Balance is a number used to match emulsifying agents with fats and oils to create stable oil-in water and water-in oil emulsions.

Hydroxyethyl cellulose: a polymer synthesized from cellulose.

Methyl cellulose: a polymer synthesized from cellulose.

Mode of Action (MOA): the means by which a pesticide exerts a desirable effect upon a pest species. The insecticide Resistance Action Committee (IRAC) identifies thirty-two distinct modes of action and five distinct categories of unknown modes of action.

Pectin: a structural heteropolysaccharide contained in the primary cell wails of terrestrial plants.

Pesticide: a chemical composition that exerts a desirable effect on a pest species, and depending upon activity, be considered by those skilled in the art to be any of: insecticides, acaricides, fungicides, bactericides, nematicides, and herbicides.

Phytotoxic: negative affect on plant tissues and/or growth resulting from chemical exposure.

Polymer: a substance that has a molecular structure consisting chiefly or entirely of a large number of similar units bonded together.

Spiracle: a respiratory opening in arthropods and hexapods.

Surfactant: a substance which tends to reduce the surface tension of the liquid in which it is dissolved. In agriculture they are used to prevent spray droplets from beading on foliage and rolling off, to instead spread droplets as a film over leaf surfaces.

### Description

The present invention provides for novel formulations of pesticides that mimic the mode of action of classic, petroleum based horticultural oils, while having compatibility with sulfur applications and breaking down rapidly in the environment.

The base composition of the invention is a pesticide wherein vegetable and/or other plant-based oils are alkalized with a base to a pH between 7.5 and 9.7, treated with one or more emulsifiers to create an oil in water emulsion (when mixed with water prior to application), and coupled with one or more of the polymers from Table 1 to create an oil/polymer film for purposes of controlling arthropod and hexapod pests, deterring herbivory, and to serve as a protective barrier between pathogens and plant surfaces.

TABLE 1
Polymers of Natural Origin that Show Low Phytotoxicity when
Combined with 0.5% Solutions of an Alkalyzed and Emulsified
Corn Oil Applied to Vitis Vinifera cv. Chardonnay Within
24 Hours of an Application of Dusting Sulfur

Agar
Arrowroot
Carrageenan
Cassava
Cellulose
Cellulose acetate
Chitin
Collagen
Cornstarch
Gelatins
Guar gum
Gum Arabic
Hydroxyethyl cellulose
Hydroxypropyl methyl cellulose
Methylcellulose
Pectin
Xanthum gum

Any base may be used, but bicarbonate salts are the preferred base for alkalizing the oil of the base composition of the invention, as they are FIFRA 25(b) listed ingredients, meaning they have been scrutinized by the United States Environmental Protection Agency and deemed to pose a minimal risk to the environment when used in pesticides.

It is a discovery of the invention that the base composition of the invention behaves similar to a standard horticultural oil, but may be applied in agricultural and horticultural settings where sulfur is used with much less likelihood of causing phytotoxic stresses. The science behind this is two-fold. Firstly, the alkali nature of the base composition of the invention neutralizes the acidic nature of sulfur compounds. Secondly, the overall effect of the base composition of the invention requires 80% less actual oil per treated area than a standard horticultural oil. Less oil reduces the probability of phytotoxic interactions and negative environmental effects. It is presumed that polymers substitute for part of a horticultural oil's MOA. Used alone, though, Table 1 polymers are marginally effective pesticides at best and do not adequately replace the role of standard horticultural oils in agriculture.

The base composition of the invention utilizes plant-based oils versus mineral or paraffinic oils. While the invention could have included petroleum-based oils, they are long lived, come from a non-renewable resource, serve no useful purpose in the environment, and thus are in disharmony with the spirit of the invention. Vegetable oils are metabolized by plants, animals, bacteria and fungi. Most vegetable oils contain about twice the calories per gram as carbohydrates. In a pesticide application a percentage of the pesticide targeted at the foliage ends up in the soil. When that pesticide is a vegetable oil, microflora and micro-fauna will utilize that oil as an energy source and increase in numbers. This will result in greater nutrient availability to plants. If a percentage of vegetable oil in a pesticide application is absorbed into leaves or roots, it will be metabolized and increase plant growth. It is without debate that plants metabolize vegetable oils as an energy source. That is why they produce the oil in the first place and why so much of it is shunted to their precious seeds. if a petroleum-based oil should be absorbed into a plant it serves no useful purpose and could possibly gunk up stomates and internal plumbing (phloem and xylem).

It is well known by those skilled in the craft that wetting agents reduce surface tension of water, resulting in spray droplets that are more likely to spread and adhere to surfaces than bead and drip from them. Wetting agents that get into the soil'are known to improve the permeability of soils and to enable plants to more easily take up water, especially as soils dry. Wetting agents combined with the base composition of the invention are considered part of the invention.

Plants produce chemicals which protect them from insects, mites, mammals, and pathogens. Often these protective chemicals are present in essential plant oils. It is widely known by those skilled in the art that certain plant essential oils have pesticidal activity. Among these are: cedarwood, cinnamon, citronella, dove, cornmint, eugenol, garlic, geranium, lemon grass, linseed, mint, peppermint, rosemary, spearmint, thyme, and wintergreen. Essential oils widely known by those skilled in the art as possessing pesticidal activity, when combined with the base composition of the invention are considered part of the invention.

### Contribution to the Art

The base composition of the invention provides environmentally friendly horticultural oils compatible with concurrent sulfur use. The addition of wetting agents can enhance efficacy of the base composition, and the addition of certain plant essential oils can expand the breadth of pests controlled.

### EXAMPLES

### Example 1

1.25 milliliters cottonseed oil (oil)+0.156 milliliters sodium bicarbonate (base)±0.625 milliliters cetyl alcohol (emulsifier)±0.156 milliliters pectin (polymer) are added to 4 ounces of distilled or deionized water and the solution then diluted to 8 ounces by adding more water. This is added to a spray bottle and the polymer allowed to hydrate for fifteen minutes. The solution is shaken and then sprayed on roses to kill spider mites and to encapsulate spores of potential pathogens and to act as a barrier to prevent powdery mildew disease.

### Example 2

1.5 milliliters safflower oil (oil)+0.156 milliliters potassium bicarbonate (base) 0.525 milliliters polyethylene glycol (emulsifier)+0.312 milliliters kappa carrageenan (polymer)+0.156 milliliters Polyether modified trisiloxane (wetting agent and emulsifier) are added to 4 ounces of distilled or deionized water and the solution then diluted to 8 ounces by adding more water. This is added to a spray bottle and the polymer allowed to hydrate for fifteen minutes. The solution is shaken and then sprayed on a cucumber vine to eliminate powdery mildew and to knock down a whitefly infestation.

### Example 3

1.5 milliliters palm oil (oil)+0.156 milliliters ammonium bicarbonate (base)+0.625 milliliters sorbitan monolaurate (emulsifier and wetting agent)+0.156 milliliters agar (polymer)+0.156 milliliters gum Arabic (polymer and emulsifier)+2 milliliters peppermint oil (essential oil) are added to 4 ounces of distilled or deionized water and the solution then diluted to 8 ounces by adding r lore water. This is added to a spray bottle and the polymers allowed to hydrate for fifteen minutes. The solution is shaken and then sprayed on gerbera daisies to eliminate powdery mildew and to knock down an aphid infestation.

### Example 4

1.5 milliliters castor oil (oil)+0.156 milliliters potassium hydroxide (base)+0.625 milliliters sorbitan monlaurate (emulsifier and wetting agent)+0.312 milliliters cassava powder (polymer)+0.156 milliliters gum Arabic (polymer and emulsifier)+2 milliliters cinnamon oil (essential oil) are added to 4 ounces of distilled or deionized water and the solution then diluted to 8 ounces by adding more water. This is added to a spray bottle and the polymers allowed to hydrate for fifteen minutes. The solution is shaken and then sprayed on ornamental plants to deter browsing by deer.

What is claimed is:

1. A pesticide wherein vegetable and/or other plant-based oils are alkalized with a base to a pH between 7.5 and 9.7, treated with one or more emulsifiers to create an oil in water emulsion (when mixed with water prior to application), and coupled with a polymer or multiple polymers to create an oil/polymer film for purposes of controlling arthropod pests and to coat plant surfaces to deter herbivory and to serve as protective barrier between pathogens and plant surfaces.

2. The composition of claim 1 wherein a wetting agent (HLB between 7 and 10) is added.

3. The compositions of claims 1 and 2 wherein the oil/polymer film includes at least one plant derived essential oil from the group consisting of, cedarwood, cinnamon, citronella, clove, cornmint, eugenol, garlic, geranium, lemon grass, linseed, mint, peppermint, rosemary, spearmint, thyme, and wintergreen.
